(19) United States
(12) Patent Application Publication
(10) Pub. No.: US 2026/0291372 A1
(43) Pub. Date: Sep. 24, 2026

(54) VOLTAGE CONVERTER FOR A HYDROGEN POWER SUPPLY SYSTEM OF A VEHICLE

(71) Applicant: OBSHCHESTVO S OGRANICHENNOI OTVETSTVENNOSTIU "EVOKARGO", Moscow (RU)

(72) Inventors: Anastasiya Borisovna Pyrkova, Afipskij (RU); Lev Nikolaevich Butov, Moscow (RU); Pavel Vladimirovich Pyrkov, Kuznetsk (RU)

(21) Appl. No.: 19/477,517

(22) PCT Filed: May 31, 2024
(86) PCT No.: PCT/RU2024/050117

§ 371 Date: Oct. 22, 2025

(30) Foreign Application Priority Data
Jun. 2, 2023 (RU) 2023114599

(51) Int. Cl. H02M 1/088; B60L 50/70; B60L 53/20; H02M 1/00

(52) U.S. Cl. CPC H02M 1/088; B60L 50/70; B60L 53/20; H02M 1/0009; B60L 2210/10

(57) ABSTRACT

The invention relates to a voltage converter for a hydrogen power system of a vehicle, which consists of a housing, a controller, a load interrupter switch, a pre-charge resistor, a choke, a current sensor, an IGBT module, a buffering capacitor, a fuse link and diodes. The current sensor and a diode, which form a constituent part of the IGBT module, are connected to the outlet of the choke. Connected to the IGBT module are an outlet-side buffering capacitor, a diode, and a current sensor for monitoring the output voltage, wherein the buffering capacitor and the diode form an output cascade of the converter. The fuse link, serving as a protective device, is mounted in front of the outlet of the voltage converter. The controller of the voltage converter is connected to a control system comprised of fuel cell control boards. Information from the fuel cells is collected on a main control board. Connected to the controller of the voltage converter is an IGBT driver that is used to control the IGBT module of a DC-DC step-up voltage converter. The invention makes it possible to power the systems of the vehicle at the same time as charging a rechargeable battery.

### FIELD OF THE INVENTION

The present invention relates to the field of electrical engineering, particularly to DC voltage converters that convert the output voltage of a power supply system based on hydrogen-air fuel cells to the level of a high-voltage circuit of an electric vehicle and control the operation of the power supply system of a highly automated vehicle (HAV).

### BACKGROUND

There are many conventional energy converters used for various applications.

There is a voltage inverter known from RU 2675726 C1, B60L 1/100, made public Dec. 24, 2018, which comprises a choke and a control system, two converter cells connected in series with the choke. The converter cells have two stages: the first stage is a three-level step-up voltage regulator containing two power switches, two diodes, two capacitors forming a capacitive voltage divider, while the second stage is a half-bridge resonant converter, where a pair of series-connected semiconductor switches is used as power switches, the load of the half-bridge resonant converters are the primary windings of one common transformer, the output windings of the transformer are loaded onto rectifiers, the outputs of which are connected in parallel.

Among the drawbacks of the known solution is the fact that the power part contains a large number of semiconductor diodes and transistors, as well as windings, thereby increasing the weight and size of the device and reducing its efficiency. Another drawback is the lack of input current meters, which are necessary for monitoring and controlling electrochemical processes in hydrogen-air fuel cells, which, in turn, narrows the scope of this device.

There is a voltage converter with key protection known from RU 2549526 C2, G05F 1/00, made public on Apr. 27, 2015, designed to provide power to various loads and powered by a DC voltage source, comprising a control device to increase the device's security in case of an accident. The converter contains a step-up regulator based on two switches and two diodes, an input voltage sensor, an input current sensor, a contactor, an input key with a resistor connected to its power terminals, a capacitor and a winding of a transformer in the diagonal of a DC/DC converter, and a voltage sensor at the output of the step-up regulator.

The drawbacks of the known solution include the use of two conversion stages to provide galvanic isolation of input and output circuits, as well as a large number of semiconductor devices and passive components necessary for the required switching sequence of the circuit in order to ensure the intended level of protection of power transistors. Said features make the control system more complicated, increase the weight and size of the device and reduce its efficiency.

There is a static voltage converter known from RU 2762338 C1, H02M 3/337, made public on Dec. 20, 2021, which comprises a capacitor at the input with a choke connected to it, forming a DC region. Two three-level step-up converters connected in series, each loaded on its own half-bridge voltage inverter, are connected to the output of the choke. Each of these step-up converters and the voltage inverters connected to them are made up of IGBT modules and power capacitors. Between the midpoint of the power capacitors of the step-up converter and the midpoint of the power switches of the voltage inverter connected to it, a resonant capacitor, a resonant choke and the primary winding of a common high-voltage power transformer are arranged in series, forming a series resonant circuit. The control system outputs control signals either to the IGBT modules of the step-up converter or to the power switches of the half-bridge voltage inverter, depending on the operating mode.

The drawbacks of the known solution include the use of multiple conversion stages to ensure galvanic isolation of input and output circuits and to ensure reversibility of the conversion, as well as a large number of semiconductor devices and windings, which increase the weight and size of the device and reduce its efficiency. Another drawback is the lack of a control system for monitoring and controlling the voltage received from hydrogen-air fuel cells, which, in turn, narrows the scope of this device.

### SUMMARY OF THE INVENTION

The technical problem to be solved by the proposed invention is to provide a DC/DC voltage converter with a control system and a power of 5 kW to increase the output voltage of a hydrogen power supply system (PSS) in a highly automated vehicle (HEV).

The objective of the proposed invention is to convert the output voltage of a hydrogen power supply system to a high DC voltage of the on-board grid, thereby allowing energy consumption for the needs of the HAV while also increasing the battery charge level.

The objective of the invention is achieved by a voltage converter for a hydrogen power supply system of a vehicle that comprises a housing containing a load switch with a precharge resistor and a choke connected to it, forming a DC link, wherein a current sensor and a diode, which are integral parts of an IGBT module, are connected to an output of the choke, and wherein an output buffer tank and a diode, which make up an output stage of the converter, and a current sensor for monitoring the output voltage are connected to the IGBT module; in addition, a fuse link is installed in front of an output of the voltage converter as a safety device for opening the circuit, if necessary, wherein a controller of the voltage converter is connected to a control system formed by control boards of at least two fuel cells, the data from which are assembled on a main control board of a hydrogen-air fuel cell, as well as communicates with an external control system for data exchange; in addition, an IGBT driver is connected to the controller of the voltage converter, which is used to control the IGBT module of a step-up DC/DC voltage converter.

Preferably, a rechargeable battery (serving as an auxiliary power source of the HEV) is connected to the voltage converter to be used in a highly automated vehicle.

The technical solution used in this device has an automated control system that allows to perform the following functions: measuring current and voltage at the input and output of the voltage converter, regulating the choke current, maintaining a set voltage at the output of the converter, performing protective shutdown of the transistor when the voltage or current exceed the permissible values, regulating the current consumed by the hydrogen power supply system on the pre-set command, exchanging data, receiving and issuing discrete signals for interaction with an external control system and control boards of fuel cells in the PSS.

### BRIEF DESCRIPTION OF THE DRAWINGS

FIG. 1 shows an electrical diagram of the auxiliary power source, in which

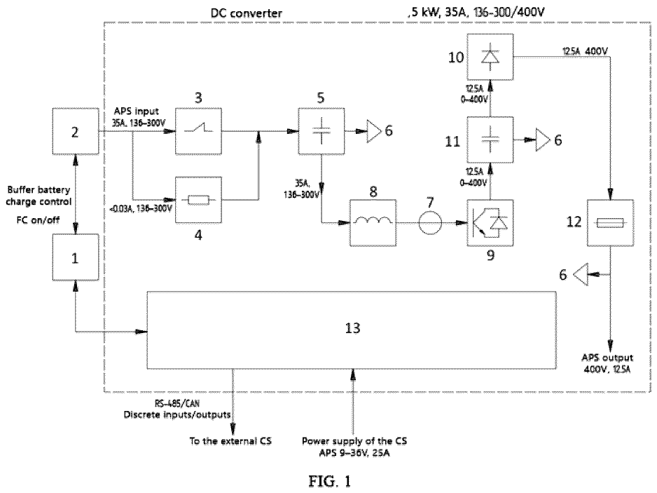

1. PSS control system

2. FC battery

3. Load input switch

4. Precharge resistor

5. Input buffer capacity

6. Voltage sensor

7. Current sensor

8. Choke

9. Step-up converter

10. Reverse current limiting diode

11. Output buffer capacity

12. Fuse link

13. Voltage converter controller

FIG. 2 shows a functional diagram of the auxiliary power source, in which

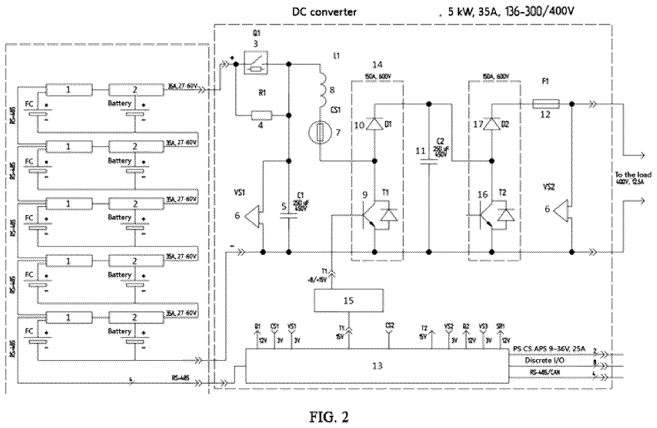

1. PSS control system

2. FC battery

3. Load input switch

4. Precharge resistor

5. Input buffer capacity

6. Voltage sensor

7. Current sensor

8. Choke

9. Step-up converter

10. Reverse current limiting diode

11. Output buffer capacity

12. Fuse link

13. Voltage converter controller

14. IGBT module

15. IGBT driver

16. Inverse-parallel IGBT transistor diode

17. Converter output diode

The DC/DC voltage converter has a housing, which contains the load input switch (3) with a precharge resistor (4) and a choke (8) connected to it, forming a direct current link. For energy storage, a buffer capacity is installed at the input (5), and the voltage is monitored by a voltage sensor (6). A current sensor (7), an IGBT transistor of the step-up converter (9) and a diode providing an alternative current flow to the load (10) in the power output cycle, forming an IGBT module (14), are connected to the output of the choke (8) A buffer capacity at the output (11) and a sensor (6) for monitoring the output voltage are connected to the IGBT module (14). The inverse-parallel diode of the IGBT transistor and the transistor itself are not involved in energy conversion (16), and the output diode (17) performs the separation function of the load and the output of the step-up stage. A fuse link (12) is installed in front of the voltage converter output as a safety device to open the circuit if necessary.

The voltage converter controller (13) is connected to the PSS control system (1), formed by control boards for each fuel cell, data from which is accumulated in the main control board of the fuel cell, and communicates with an external control system for exchanging data via the CAN/RS-485 interface (status of hydrogen-air fuel cells and voltage converter, sending commands to turn the fuel cells on or off). The IGBT module (14) of the step-up converter is controlled using the IGBT driver (15), which is also connected to the voltage converter controller (13). To compensate for the lack of power, the FC battery (2) is connected to the voltage converter, whereas the batteries are controlled by the PSS control system (1).

### DETAILED DESCRIPTION OF THE INVENTION

When 24 V power is applied to the voltage converter, the control system is initialized, and the device is in the POWERUP mode. In this mode, the voltage converter waits for communication with the hydrogen-air fuel cells that are part of the power supply system; data are received from the main control board (MCB) located on the first fuel cell, wherein the data contains combined information about the five fuel cells. If there is a connection with the PSS, the voltage converter switches to the STANDBY mode, in which it waits for the start command from the control board (BMS) of the traction battery (TB).

When the READY TO CHARGE start command is received from the BMS, if there are no errors, the voltage converter sends a command to turn on each fuel cell and switches to STARTUP mode. In this mode, a signal from the fuel cell about successful start is awaited for a maximum of 45 seconds; each of the fuel cells is activated and emergency conditions are monitored. If there are none, the control boards transmit ACTIVE signals to the converter. After they are received and the charging of the input capacitor of the voltage converter is finished, the relay that shunts the input charging resistor is closed and the READY mode is switched on.

If there are no errors and a signal to allow charging has been sent from the BMS, the voltage converter sends a signal to the power unit and begins to operate as a current controller. At the initial stage, the device switches to the CHARGING_START mode, in which the current consumed from the fuel cells increases gradually for 60 seconds, starting from 5 A. After that, the device is set into CHARGING mode.

The algorithm for maintaining constant current tends to the value of 30 A if there are no limiting factors. A slow proportional-integral controller (PI controller) is used to maintain the current consumption value. Voltage limits are used in the PI controller operation. An additional algorithm has been implemented that compares the minimum voltage among the five fuel cells and the normal fuel cell voltage of 32.5 V. If the minimum voltage among the fuel cells is greater than 32.5 V, the converter gradually increases current consumption, if it is lower, then current consumption is decreased. At the same time, the upper limit of current consumption corresponds to the external (relative to the control system) setting of current consumption and lies within the range of 5 . . . 30 A.

When the current controller is operating, if at least one of the fuel cell voltages decreases to the threshold level of 30 V and does not bounce back for 5 seconds, the voltage converter performs an emergency shutdown. In addition, an emergency shutdown is performed in case of any of the fuel cell errors that have not been reset within 5 seconds.

The device shutdown can be initiated by the BMS or the PSS control system (a similar CAN protocol is transmitted via the RS-485 interface). The shutdown algorithm:
1) The signal for the operation of the power unit is turned off.
2) A signal to turn off the fuel cells is sent.
3) The relay that shunts the charging resistor opens.

If the emergency shutdown was performed due to an error, the voltage converter tries to restart in five seconds by resetting the error and switching to the WAIT standby mode for 10 seconds, during which it checks for new errors, after which, if there is a permission from the BMS, it starts. In case an error comes up again, the shutdown and restart algorithm is repeated until three unsuccessful attempts are made.

Therefore, the disclosed device is used as a DC/DC converter of the output voltage of a power supply system based on hydrogen-air fuel cells (120-320 V) to a high DC voltage of the on-board power supply of the HEV equal to the voltage of the traction battery (330-380 V).

The proposed invention meets the industrial applicability criterion and can be implemented on any ground-based autonomous highly automated vehicles.

1. A voltage converter for a hydrogen power supply system of a vehicle comprising:
a housing containing a load switch with a precharge resistor and a choke connected to it, forming a DC link;
a current sensor and a diode, which are integral parts of an IGBT module, are connected to an output of the choke;
wherein the IGBT module connected with
an output buffer tank and a diode, forming an output stage of the voltage converter;
a current sensor for monitoring the output voltage;
a fuse link is installed in front of an output of the voltage converter, wherein the fuse link works as a safety device for opening the circuit,
a controller of the voltage converter connected to a control system, which is formed by control boards of at least two fuel cells, from which a data is gathered on a main control board of a hydrogen-air fuel cell;
wherein the controller of the voltage converter communicates with an external control system for data exchange;
wherein the controller of the voltage converter connected with an IGBT driver, which is used to control the IGBT module of a step-up DC/DC voltage converter.
